(19) United States
(12) Patent Application Publication
(10) Pub. No.: US 2024/0382021 A1
(43) Pub. Date: Nov. 21, 2024

(54) ARTWARE FLOWER RECEPTACLE STRUCTURE

(71) Applicant: HUIZHOU DICHENG ELECTRONIC TECHNOLOGY CO., LTD, Huizhou City (CN)

(72) Inventor: BINJIE PAN, Huizhou City (CN)

(21) Appl. No.: 18/317,108

(22) Filed: May 15, 2023

(51) Int. Cl. A47G 7/06; F21V 23/04; F21V 31/00

(52) U.S. Cl. CPC A47G 7/06; F21S 10/002; F21V 33/0028; A47G 2200/08; A47G 2200/10; A47G 2200/14; F21Y 2115/10

(57) ABSTRACT

Provided is an artware flower receptacle structure, including a base including a control circuit inside; a water lamp body arranged on the base, the water lamp body being in a hollow and light-transmissive three-dimensional shape, and holding flowable liquid inside in a sealed manner; a flower receptacle base connected to the base or the water lamp body, a flower receptacle groove being formed in the flower receptacle base; and a light-emitting unit electrically connected to the control circuit. According to the artware flower receptacle structure, the flower receptacle base is arranged on the water lamp body or the base, and thus the base, the water lamp body and the flower receptacle base form a diverse and unique three dimensional shape; then the flowers are arranged into the flower receptacle groove, so that the art of flower arrangement and the unique three-dimensional shape of the flower receptacle are combined.

### BACKGROUND

### Technical Field

The present invention relates to the technical field of flower receptacles, and in particular, to an artware flower receptacle structure.

### Related Art

A flower receptacle is a base for flower arrangement. The base is usually made of a lead block and densely covered with pointed copper nails. There are various styles of bases, for example, a square base, a circular base, and a polygonal base. Flower stems are inserted on copper nails in various forms to show the artistry of flower arrangement. The term “flower receptacle” was first introduced in the Ming Dynasty. The shape of a flower receptacle includes a spherical shape, a plum blossom tube shape, and a drum shape. The body of a flower receptacle is often decorated with blue-and-white interlocking lotus patterns, gardenias patterns or blue-and-white reverse-painted interlocking lotus patterns. In the Qing Dynasty, flower receptacles continued to be fired, with slight changes in shape and richer varieties, including an imitation Ge glaze, a pink celadon glaze, and a sky-blue glaze.

Existing flower receptacles usually have monotonous and conservative structure forms, while flower arrangement is an artistic activity. With the growing demand for life style, consumers have increasingly high requirements for the structural forms of flower receptacles for flower arrangement. Consumers are more likely to accept and enjoy structural forms of flower receptacles with a sense of design and a sense of art.

Therefore, in order to satisfy consumers' pursuit of the sense of design and the sense of art in the structural forms of flower receptacles, the inventor provides the present invention based on the experience of many years in ornaments in combination with the US patent “Flower receptacle with water lamp handicraft U.S. Pat. No. 11,499,705 B1”.

### SUMMARY

The objective of the present invention is to provide an artware flower receptacle structure having a strong sense of design, a strong sense of art, and a better viewing effect.

In order to solve the above-mentioned technical problem, the present invention may be implemented by using the following technical solutions:

An artware flower receptacle structure, comprising:
a base comprising a control circuit inside;
a water lamp body arranged on the base, the water lamp body being in a hollow and light-transmissive three-dimensional shape, and holding flowable liquid inside in a sealed manner;
a flower receptacle base connected to the base or the water lamp body, a flower receptacle groove being formed in the flower receptacle base; and
a light-emitting unit electrically connected to the control circuit.

In an embodiment, the flower receptacle base is connected to the base, with the flower receptacle base wrapped around the water lamp body or located on one side of the water lamp body.

In an embodiment, the flower receptacle base is made of a transparent or light-transmissive material.

In an embodiment, the present invention further comprises a stirring assembly, wherein the stirring assembly comprises a driving member arranged in the base and a magnetic shifting member arranged in the water lamp body, the driving member is connected to the control circuit, the driving member has a magnetic shaft, and the magnetic shifting member is driven to rotate by magnetic attraction of the magnetic shaft, so as to enable the liquid inside the water lamp body to flow.

In an embodiment, the magnetic shifting member comprises a body and a sleeve, the body has a magnet inside, fixing grooves are formed at both ends of the body, a clamping groove is formed in a side wall of the body, the sleeve is of a hollow structure and sleeved over the clamping groove, and a plurality of blades is evenly distributed at an outer wall of the sleeve.

In an embodiment, the control circuit has a changeover switch, and the changeover switch is capable of controlling the light-emitting unit to turn on/off, and controlling the driving member to start/stop.

In an embodiment, the changeover switch is a mechanical changeover switch arranged on the base or a remote changeover switch with remote control.

In an embodiment, a support, a rotating body and a ball ring are arranged in the water lamp body, one end of the support is connected to an inner bottom of the water lamp body, an external rotation groove is formed in an other end, the rotating body is sleeved over the support and has an internal rotation groove corresponding to the external rotation groove, and the ball ring is arranged between the external rotation groove and the internal rotation groove, so that the rotating body is rotatably connected to the support through the ball ring, the magnetic shifting member is arranged between the support and the inner bottom of the water lamp body and configured to stir the liquid inside the water lamp body to flow, so as to enable the rotating body to rotate passively with flow.

In an embodiment, an ornament is arranged on the rotating body, and the ornament rotates with the rotating body.

In an embodiment, the control circuit is further connected to a generation unit configured to play music, and a power supply of the control circuit is an external power supply or an internal battery.

Beneficial effects are as follows:

The artware flower receptacle structure mainly includes the base, the water lamp body and the flower receptacle, and has a few components and a simple structure. The flower receptacle base is arranged on the water lamp body or the base, and in a case of being arranged on the base, the flower receptacle base may wrap the water lamp body, and thus the base, the water lamp body and the flower receptacle base form a diverse and unique three-dimensional shape; then the flowers are arranged into the flower receptacle groove of the flower receptacle base, so that the art of flower arrangement and the unique three-dimensional shape are combined; and finally, the entire flower receptacle has a strong sense of design, a strong sense of art, and a better viewing effect, so as to satisfy consumers' pursuit of the sense of design and the sense of art in the structural forms of flower receptacles.

### BRIEF DESCRIPTION OF THE DRAWINGS

FIG. 1 is a schematic structural diagram I of an artware flower receptacle structure according to the present invention;

FIG. 2 is a schematic structural diagram II of the artware flower receptacle structure according to the present invention;

FIG. 3 is a schematic structural diagram of a magnetic shifting member of the artware flower receptacle structure according to the present invention;

FIG. 4 is a schematic structural diagram of a support, a rotating body and a ball ring of the artware flower receptacle structure according to the present invention;

FIG. 5 is a schematic structural diagram of the artware flower receptacle structure according to another embodiment of the present invention;

FIG. 6 is a schematic structural diagram I of the artware flower receptacle structure according to yet another embodiment of the present invention; and

FIG. 7 is a schematic structural diagram II of the artware flower receptacle structure according to yet another embodiment of the present invention.

### DETAILED DESCRIPTION

To make the foregoing objectives, features, and advantages of the embodiments of the present invention more comprehensible, specific implementations of the present invention are described in detail below with reference to the accompanying drawings. In the following description, many specific details are described to give a full understanding of the present invention. However, the present invention may be implemented in many other manners different from those described herein. A person skilled in the art may make similar improvements without departing from the connotation of the present invention. Therefore, the present invention is not limited to the specific embodiments disclosed below.

It is to be noted that, when a component is referred to as “being fixed to” another component, the component may be directly on the other component, or an intervening component may be present. When a component is considered to be “connected to” another component, the component may be directly connected to the another component, or an intervening component may also be present. In contrast, when a component is referred to as being “directly on” or “directly connected to” another component, there is no intervening component. The terms “vertical”, “horizontal”, “left”, and “right” and similar expressions used in this specification are merely used for the purpose of description.

Unless otherwise defined, meanings of all technical and scientific terms used in this specification are the same as those usually understood by a person skilled in the art to which the present invention belongs. In this specification, terms used in the specification of the present application are merely intended to describe objectives of the specific embodiments, but are not intended to limit the present invention. The term “and/or” used in this specification includes any and all combinations of one or more related listed items.

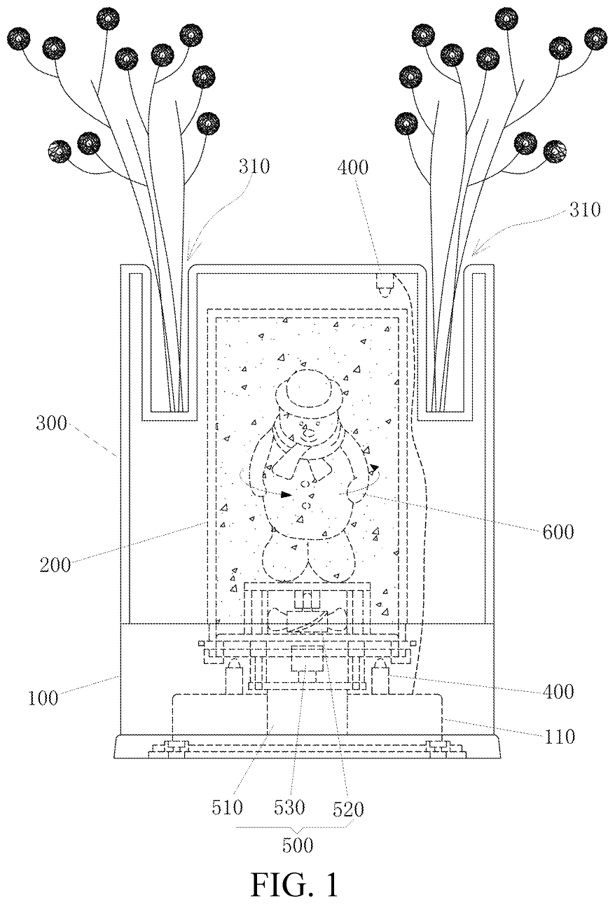

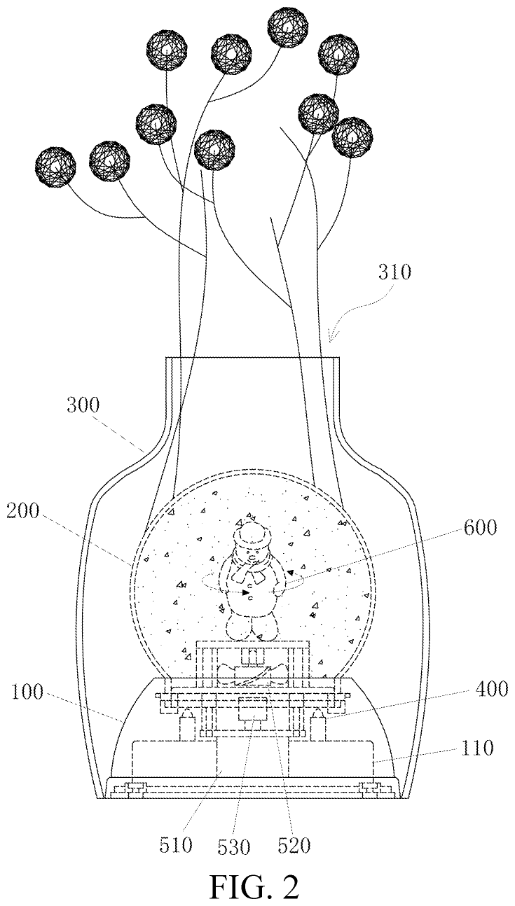

Referring to FIG. 1 and FIG. 2, an artware flower receptacle structure includes:
a base 100 including a control circuit 110 inside;
a water lamp body 200 arranged on the base 100, the water lamp body 200 being in a hollow and light-transmissive three-dimensional shape, and holding flowable liquid inside in a sealed manner;
a flower receptacle base 300 connected to the base 100 or the water lamp body 200, a flower receptacle groove 310 being formed in the flower receptacle base 300; and
a light-emitting unit 400 electrically connected to the control circuit 110.

Specifically, in this embodiment, the flower receptacle structure mainly includes the base 100, the water lamp body 200 and the flower receptacle 300, and has a few components and a simple structure. The water lamp body 200 is arranged on the base 100. The flower receptacle base 300 may be arranged on the water lamp body 200 or the base 100; and in a case that the flower receptacle base 300 is connected to the base 100, the flower receptacle base 300 may wrap the water lamp body 200, and thus the flower receptacle base 300, the water lamp body 200 and the base 100 form a three-dimensional shape having a strong sense of design and a strong sense of art, so as to improve the viewing effect of the flower receptacle, and satisfy consumers' pursuit of the sense of design and the sense of art in the structural forms of flower receptacles.

At the same time, in order to make the flower receptacle structure have the strong sense of design and the strong sense of art, in this embodiment, the flower receptacle structure further includes the light-emitting unit 400. The light-emitting unit 400 may be arranged in the base 100, and electrically connected to the control circuit 110 in the base 100. The light-emitting unit 400 is located correspondingly to the water lamp body 200. The light-emitting unit 400 may be powered by the control circuit 110, so that the light-emitting unit 400 emits light, a light ray emitted by the light may be projected to the water lamp body 200, and then the light ray is projected by the water lamp body 200. In combination with the projected light ray, the water lamp body 200, the flower receptacle base 300 and arranged flowers with a unique shape, the entire flower receptacle structure has the strong sense of design and the strong sense of art, thereby improving a viewing effect.

Of course, the light-emitting unit 400 may also be arranged in an inner wall of the flower receptacle base 300, and connected to the control circuit 110 through wires, thereby achieving illumination of the water lamp body 200. The emitted light ray may also achieve illumination of the flower receptacle base 300.

In order to improve a viewing effect, in this embodiment, the flower receptacle base 300 may be made of a transparent or light-transmissive material. The transparent material allows direct viewing of the internal water lamp body 200 and allows the light emitted by the light-emitting unit 400 to be transmitted, and the light-transmissive material allows the light ray from the light-emitting unit 400 to be transmitted.

In addition, in this embodiment, the flower receptacle base 300 may also be hollowed-out. The hollowed-out flower receptacle base 300 transmits the light ray from the light-emitting unit 400. The water lamp body 200 can be viewed visually. Finally, the viewing effect of the flower receptacle is improved and consumers' pursuit of the sense of design and the sense of art of the flower receptacle is satisfied.

In this embodiment, in order to achieve the control over the light-emitting unit 400, the control circuit 110 has a changeover switch (not shown). The changeover switch may be a mechanical changeover switch arranged on the base 100 or a remote changeover switch with remote control, and capable of controlling the control circuit 110 to start/stop, so as to achieve on/off of the light-emitting unit 400. When the changeover switch is the mechanical changeover switch, the changeover switch may be arranged at a bottom, top or side of the base 100. Of course, a touch switch may also be selected.

A power supply of the control circuit 110 may be an external power supply or an internal battery. The light-emitting unit 400 is an LED. The LED is small, thus can facilitate the installation of the light-emitting unit 400, and can reduce energy consumption, so that the flower receptacle structure is more environmentally friendly.

Further, in this embodiment, the artware flower receptacle structure includes a stirring assembly 500. The stirring assembly 500 includes a driving member 510 arranged in the base 100 and a magnetic shifting member 520 arranged in the water lamp body 200. The driving member 510 is connected to the control circuit 110. The driving member 510 has a magnetic shaft 530. The magnetic shifting member 520 is driven to rotate by magnetic attraction of the magnetic shaft 530, so as to enable the liquid inside the water lamp body 200 to flow.

By manipulating the changeover switch, the control circuit 110 controls the driving member 510. The driving member 510 is a motor. The driving member 510 drives the magnetic shaft 530 to rotate. When the magnetic shaft 530 rotates, the magnetic shifting member 520 inside the water lamp body 200 is driven to rotate due to a magnetic attraction principle. When the magnetic shifting member 520 rotates, the liquid inside the water lamp body 200 is stirred, so as to enable the liquid to flow. The light emitted by the light-emitting unit 400 is refracted by the flowing liquid, so that the light emitted by the water lamp body 200 is more dazzling and colorful, and has a better visual perception. In addition, in combination with different shapes of the water lamp body 200, the flower receptacle base 300 and the flowers in the flower receptacle groove 310, the flower receptacle has the strong sense of design and the strong sense of art.

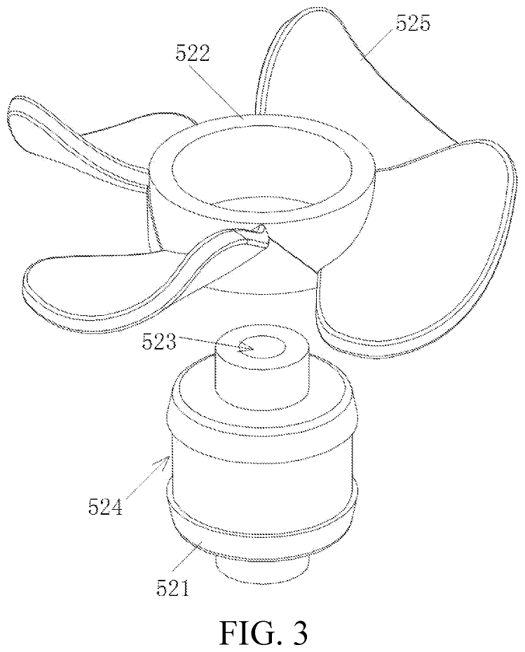

Referring to FIG. 3, in this embodiment, due to the different three-dimensional shapes of the water lamp body 200, the sizes of the internal space are different. In order to make the magnetic shifting member 520 agitate the liquid for different sizes of the internal space, in this embodiment, the magnetic shifting member 520 includes the body 521 and the sleeve 522. The body 521 has a magnet inside. Fixing grooves 523 are formed at both ends of the body 521. A clamping groove 524 is formed in a side wall of the body 521. The sleeve 522 is of a hollow structure and sleeved over the clamping groove 524. A plurality of blades 525 is evenly distributed at an outer wall of the sleeve 522.

When assembling the magnetic shifting member 520, the sleeve 522 of the hollow structure is directly sleeved over the clamping groove 524 of the body 521. When it is necessary to agitate the liquid for different sizes of internal space, only the sleeve 522 is removed from the body 521, and replaced with the sleeve 522 having different size of blades 525, or with the sleeve 522 having different shapes of blades 525. Of course, it may also be replaced with the sleeve 522 having different sizes and different shapes of blades 525, so that the blades 525 on the sleeve 522 can agitate the liquid for different sizes of internal space, so as to ensure the water agitation effect of the magnetic shifting member 520, and improve the adaptability of the magnetic shifting member 520.

The fixing grooves 523 at both ends of the body 521 are configured to facilitate the assembly and positioning of the magnetic shifting member 520. Of course, fixing columns may be arranged at both ends of the body 521, or the fixing column is arranged at one end and the fixing groove 523 is arranged at an other end, and this structure is not limited thereto.

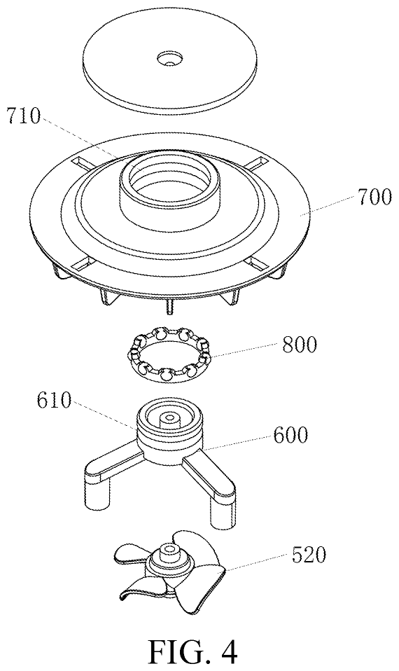

At the same time, referring to FIG. 4, a support 600, a rotating body 700 and a ball ring 800 are further arranged in the water lamp body 200. One end of the support 600 is connected to a bottom of the water lamp body 200, an external rotation groove 610 is formed in an other end. The rotating body 700 is sleeved over the support 600 and has an internal rotation groove 710 corresponding to the external rotation groove 610. The ball ring 800 is arranged between the external rotation groove 610 and the internal rotation groove 710, so that the rotating body 700 is rotatably connected to the support 600 through the ball ring 800. The magnetic shifting member 520 is arranged between the support 600 and an inner bottom of the water lamp body 200. In addition, an ornament 900 is further arranged on the rotating body 700.

When the driving member 510 drives the magnetic shaft 530 to rotate, the magnetic shifting member 520 inside the water lamp body 200 is driven to rotate due to the magnetic attraction principle. When the magnetic shifting member 520 rotates, the liquid inside the water lamp body 200 is stirred to flow. Therefore, the rotating body 700 rotate with the ball ring 800 through water resistance, so that the ornament 900 arranged on the rotating body 700 is passively rotated with flow.

Of course, the ornament 900 may also be driven by the magnetic shifting member 520 for active rotation, and an active rotation structure thereof may be implemented in combination with a rotation method in Chinese Patent No. 2021214116672, and since this structure is existed in the related art, it is not be further described herein.

Finally, the rotation of the ornament 600, the illumination of the light-emitting unit on the water lamp body and the flowers arranged in the flower receptacle base make the overall viewing effect of the flower receptacle structure better, so as to satisfy consumers' pursuit of the sense of design and the sense of art in the structural forms of flower receptacles.

Of course, the control circuit 110 may also be connected to a generation unit (not shown). The generation unit is a speaker. The speaker may be arranged in the base 100. A sound hole corresponding to the speaker may be formed in a side wall of the base 100. The speaker plays all kinds of audio, and in combination with the lighting effect in the water lamp body 200, the rotation effect of the ornament 600 and the art of flower arrangement in the flower receptacle base 300, the whole flower receptacle structure have a better auditory effect and visual effect, so that the flower receptacle structure has a better sense of design, sense of art and viewing effect, so as to satisfy consumers' pursuit of the sense of design and the sense of art in the structural forms of flower receptacles.

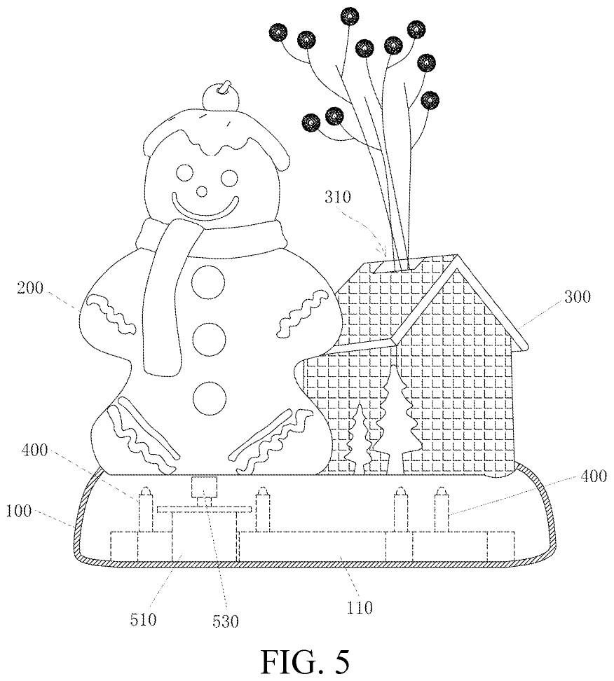

Referring to FIG. 5, in another embodiment, when the flower receptacle base 300 is connected to the base 100, the flower receptacle base 300 may also be arranged on one side of the water lamp body 200. At this time, the flower receptacle base 300 and the water lamp body 200 may be shaped into two separate and independently-arranged three-dimensional shapes, and then respectively arranged on the base 100, so that the flower receptacle structure as a whole forms another three-dimensional shape having a strong sense of design and a strong sense of art, so as to improve the viewing effect of the flower receptacle structure, and satisfy consumers' pursuit of the sense of design and the sense of art in the structural forms of flower receptacles.

In order to improve the sense of art and the viewing effect of the flower receptacle structure, the light-emitting units 400 may be arranged at corresponding positions of both the water lamp body 200 and the flower receptacle base 300, so that the flower receptacle base 300 can have light as well to illuminate the arranged flowers and make the flower receptacle have the strong sense of art.

When the light-emitting units 400 are arranged at the corresponding positions of both the water lamp body 200 and flower receptacle base 300, the changeover switch may control the light-emitting unit 400 corresponding to the water lamp body 200 and the light-emitting unit 400 corresponding to the flower receptacle base 300 to turn on or off at the same time, or control the light-emitting unit 400 corresponding to the water lamp body 200 to turn on, and control the light-emitting unit 400 corresponding to the flower receptacle base 300 to turn off, or even control the light-emitting unit 400 corresponding to the water lamp body 200 to turn off, and control the light-emitting unit 400 corresponding to the flower receptacle base 300 to turn on, so that the application of light-emitting unit 400 is more diverse, and different ways of light are presented, thereby improving the visual perception effect.

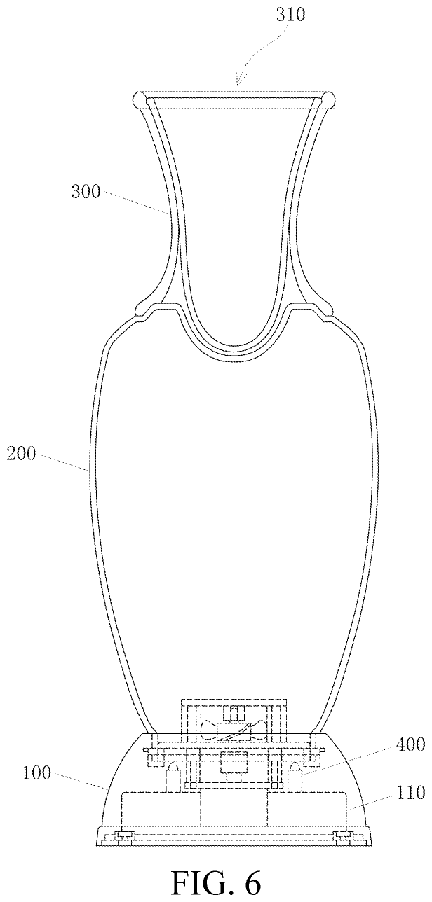

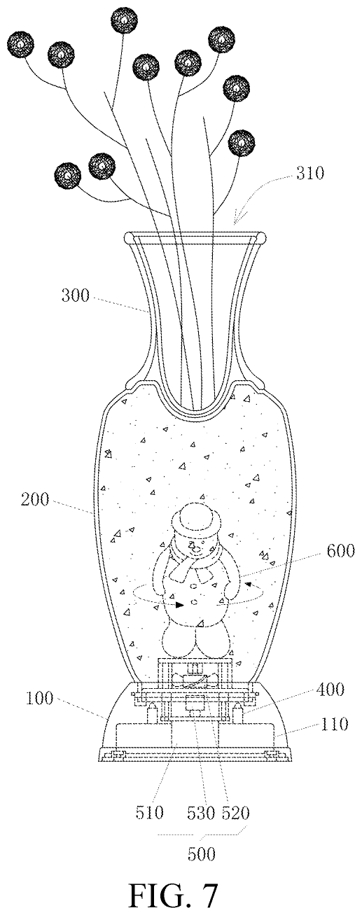

Referring to FIG. 6 and FIG. 7, in yet another embodiment, the flower receptacle base 300 may also be connected to the water lamp body 200. When the flower receptacle base 300 is arranged on the water lamp body 200, the flower receptacle base 300 may be arranged on a top of the water lamp body 200. Of course, it is not limited to the top position, the flower receptacle base may also be arranged on one side of the water lamp body 200. Specifically, according to the three-dimensional shape of the water lamp body 200, the position of the flower receptacle base 300 may be selected in real time, so that the shape of the water lamp body 200 and the shape of the flower receptacle base 300 can be combined to form a ‘vase’ shape in this embodiment. Then in combination with the flowers arranged in the flower receptacle groove 310, the flower receptacle structure form yet another three-dimensional shape having a strong sense of design and a strong sense of art, so as to improve the viewing effect of the flower receptacle, and satisfy consumers' pursuit of the sense of design and the sense of art in the structural forms of flower receptacles.

The foregoing shows and describes basic principles and main features of the present invention and advantages of the present invention. Any person skilled in the art can smoothly implement the present invention in combination with the drawings and the above. However, any equivalent changes, modifications and evolutions made by a person skilled in the art, without departing from the scope of the technical solution of the present invention, using the technical content disclosed above, are equivalent embodiments of the present invention. At the same time, any equivalent changes, modifications and evolutions made to the above embodiments based on the substantial technology of the present invention shall be included within the scope of protection of the technical solution of the present invention.

What is claimed is:

1. An artware flower receptacle structure, comprising:
a base comprising a control circuit inside;
a water lamp body arranged on the base, the water lamp body being in a hollow and light-transmissive three-dimensional shape, and holding flowable liquid inside in a sealed manner;
a flower receptacle base connected to the base or the water lamp body, a flower receptacle groove being formed in the flower receptacle base; and
a light-emitting unit electrically connected to the control circuit.

2. The artware flower receptacle structure according to claim 1, wherein the flower receptacle base is connected to the base, with the flower receptacle base wrapping the water lamp body or being located on one side of the water lamp body.

3. The artware flower receptacle structure according to claim 2, wherein the flower receptacle base is made of a transparent or light-transmissive material.

4. The artware flower receptacle structure according to claim 1, further comprising a stirring assembly, wherein the stirring assembly comprises a driving member arranged in the base and a magnetic shifting member arranged in the water lamp body, the driving member is connected to the control circuit, the driving member has a magnetic shaft, and the magnetic shifting member is driven to rotate by magnetic attraction of the magnetic shaft, so as to enable the liquid inside the water lamp body to flow.

5. The artware flower receptacle structure according to claim 4, wherein the magnetic shifting member comprises a body and a sleeve, the body has a magnet inside, fixing grooves are formed at both ends of the body, a clamping groove is formed in a side wall of the body, the sleeve is of a hollow structure and sleeved over the clamping groove, and a plurality of blades is evenly distributed at an outer wall of the sleeve.

6. The artware flower receptacle structure according to claim 4, wherein the control circuit has a changeover switch, and the changeover switch is capable of controlling the light-emitting unit to turn on/off, and controlling the driving member to start/stop.

7. The artware flower receptacle structure according to claim 6, wherein the changeover switch is a mechanical changeover switch arranged on the base or a remote changeover switch configured with remote control.

8. The artware flower receptacle structure according to claim 4, wherein a support, a rotating body and a ball ring are arranged in the water lamp body, one end of the support is connected to an inner bottom of the water lamp body, an external rotation groove is formed in an other end, the rotating body is sleeved over the support and has an internal rotation groove corresponding to the external rotation groove, the ball ring is arranged between the external rotation groove and the internal rotation groove, so that the rotating body is rotatably connected to the support through the ball ring, the magnetic shifting member is arranged between the support and the inner bottom of the water lamp body and configured to stir the liquid inside the water lamp body to flow, so as to enable the rotating body to rotate passively with flow.

9. The artware flower receptacle structure according to claim 8, wherein an ornament is arranged on the rotating body, and the ornament rotates with the rotating body.

10. The artware flower receptacle structure according to claim 1, wherein the control circuit is further connected to a sound emission unit configured to play music, and a power supply of the control circuit is an external power supply or an internal battery.
